(19) United States
(12) Patent Application Publication
(10) Pub. No.: US 2019/0292071 A1
(43) Pub. Date: Sep. 26, 2019

(54) Apparatus and Method for Monitoring the Effectiveness of a Water Treatment Unit

(71) Applicant: Hydrotech International Water treatment LTD, Swords (IE)

(72) Inventor: Wolfgang Schulze, Schwarzenbach/Salle (DE)

(21) Appl. No.: 16/354,789

(22) Filed: Mar. 15, 2019

(30) Foreign Application Priority Data
Mar. 26, 2018 (EP) EP18163832.1

(51) Int. Cl. C02F 1/00; C02F 1/38; G01N 1/40; G01N 15/06

(52) U.S. Cl. CPC C02F 1/008; C02F 1/38; C02F 1/48; G01N 15/06; G01N 1/4077

(57) ABSTRACT

The invention relates to an apparatus for monitoring the separation of lime particles from a water stream, including a water inlet via which water that contains lime particles is fed, a separation chamber, within which the lime particles are separated from the water by centrifugal forces, and a water outlet, via which the water from which the lime particles have been separated is discharged, a collection chamber being provided for receiving the lime particles separated from the water and a sensor system being provided on the collection chamber, by means of which sensor system the separation process of the lime particles from the water stream can be monitored.

### BACKGROUND OF THE INVENTION

The invention relates to an apparatus and a method for monitoring the effectiveness of a water treatment unit.

Water treatment units for chemical-free water treatment are generally known. In such units, particles (in particular microparticles) of calcium carbonate are formed from constituents present in the water. This can effectively reduce the calcification or formation of scale on devices in a water circuit, in particular a hot water circuit.

European patent application No. EP 0 525 835 A2 discloses an apparatus for removing scale, in which the water treatment is affected by a magnetic field generated by a coil. One or more deflection plates are provided inside a housing and force multiple deflection of the water as it flows through the housing.

A disadvantage is that monitoring the effectiveness of such water treatment units has been difficult thus far.

### SUMMARY OF THE INVENTION

Based on this, the object of the invention is to provide an apparatus, by means of which it is possible to check the function of a water treatment unit in a simple fashion and with high operational reliability.

According to a first aspect, the invention relates to an apparatus for monitoring the separation of lime particles from a water stream. The apparatus comprises a water inlet through which water containing lime particles is fed to a separation chamber. The separation chamber is designed in such a way that the lime particles are separated from the water by centrifugal forces in this chamber. In addition, the apparatus has a water outlet through which the water from which the lime particles were separated—hereinafter also referred to as filtered water—is discharged. A collection chamber is provided on the apparatus to collect the lime particles separated from the water. A sensor system is provided at this collection chamber by means of which the separation process of the lime particles from the water stream can be monitored.

The apparatus according to the invention offers the decisive advantage that the sensor system can be used to measure whether and to what extent lime particles can be filtered out of the water passed through the water treatment unit. The measuring signal provided by the sensor system thus allows a conclusion to be drawn as to whether a precipitation process of lime particles in the water treatment unit has taken place to the desired extent. This allows automatic function monitoring of the water treatment unit.

According to one embodiment, the sensor system is based on light or sound. Through light or sound measurement, it is in particular possible to determine the concentration of precipitated lime particles in the water in the collection chamber since the transmission properties for light or sound change depending on the lime particle concentration.

According to one embodiment, the sensor system has an arrangement comprising a transmitter and a receiver, the transmitter being designed to pass a signal emitted by it through the collection chamber to the receiver. In particular, transmitter and receiver are arranged opposite each other. This ensures that a signal emitted by the transmitter propagates through the water containing lime particles in the collection chamber and then hits the receiver. Thus, the measuring signal provided by the receiver is dependent on the lime particle concentration since the transmission properties of the water change with the lime particle concentration.

According to one embodiment, the sensor system is coupled to an evaluation and control unit by means of which the concentration of lime particles in the collection chamber can be analyzed on the basis of the measuring signal measured at the receiver. The evaluation and control unit can here, in particular, evaluate the signal strength and/or the spectral components contained in the measuring signal and, based on this, draw conclusions about the effectiveness of the precipitation of lime particles in the water treatment unit upstream of the separator.

According to one embodiment, the sensor system is coupled to an evaluation and control unit, via which the filling level of the lime particles in the collection chamber can be measured at least temporarily. The sensor system is preferably located in an upper area of the collection chamber. The lime particles separated from the water in the separation chamber are increasingly deposited in the collection chamber. In the event that the deposited lime particles have reached such a height that they reach the level of the sensor system, this can be determined by means of the measuring signal (e.g. by a drop in the signal level).

According to one embodiment, the collection chamber has an outlet valve that can be moved to an open position on the basis of a measuring signal provided by the sensor system in order to empty the collection chamber. This allows automatic discharge of the lime particles from the collection chamber. This is initiated in particular when the measuring signal indicates that the deposited lime particles have reached a height which makes it necessary to discharge the lime particles from the collection chamber.

According to one embodiment, the separation chamber has a round cross-section in order to effect a rotational movement of the water around a vertical normal axis. This is advantageous for achieving a flow in the separation chamber that allows the lime particles to be separated from the water by centrifugal force.

According to one embodiment, the water inlet is arranged at the separation chamber in such a way that the water is introduced into the separation chamber in a tangential direction. As a result, the introduced water is deflected by the curved inner wall of the separator chamber and a flow rotating about the vertical normal axis of the separator is achieved.

According to one embodiment, the separation chamber is designed to taper downwards. In other words, the separation chamber has a downward tapering cross-section. This serves to advantageously increase the speed of the rotating flow, which leads to an improved separation of the lime particles. Deviating from this, however, the cross-section, in particular the diameter of the separating chamber along its height can be constant or substantially constant.

According to one embodiment, the collection chamber is located below the separation chamber. As a result, the lime particles separated from the water can be fed downwards to the collection chamber due to gravity and/or flow.

According to one embodiment, the collection chamber is separated from the separation chamber by a separating device. This allows a flow calming in the collection chamber to be achieved and the effect of the rotating flow in the separation chamber on the lime particles in the collection chamber to be significantly reduced.

According to one embodiment, the separating device forms a gap at the edge between the wall of the separation chamber and the separating device, through which lime particles can be conveyed from the separation chamber into the collection chamber. The gap is here preferably dimensioned in such a way that the lime particles can be fed effectively from the separation chamber into the collection chamber and, at the same time, the flow in the collection chamber is calmed as much as possible. For example, the gap can have a width between 1 mm and 15 mm, in particular a width between 5 mm and 10 mm.

According to one embodiment, the sensor system is intended for monitoring the separation process of the lime particles below the separating device. This allows the lime particle concentration to be measured in a flow-calmed area.

According to a further aspect, the invention relates to a method for monitoring the function of a water treatment unit. The method here comprises the following steps:
feeding the water treated by the water treatment unit into a separation chamber of a separator, in which the water containing the lime particles is set in rotation;
separating the lime particles from the water by centrifugal forces acting on the lime particles;
feeding the lime particles into a collection chamber of the separator; and
monitoring the separation of lime particles in the collection chamber by means of a sensor system.

According to one embodiment of the method, measuring signals provided by the sensor system are fed to an evaluation and control unit and the water treatment unit is controlled on the basis of the evaluation information determined by the evaluation and control unit. For example, the electrical signal generating the magnetic field or the operating mode of the water treatment unit can be changed if the measuring signal indicates insufficient precipitation of lime particles.

“Water treatment” in the sense of the present invention means in particular that the effect of a magnetic field or an electrolysis process on the water (possibly also supported by a mechanical vibration of a vibrating unit) results in the precipitation of lime particles.

In the sense of the present invention, “lime microcrystals” or “lime particles” are defined as any particles consisting of calcium carbonate or containing at least a proportion of calcium carbonate.

The expressions “approximately”, “substantially” or “about” in the sense of the invention mean deviations from the respectively exact value by +/−10%, preferably by +/−5% and/or deviations in the form of changes that are insignificant for the function.

Further developments, advantages and possible applications of the invention also result from the following description of embodiments and from the drawings. All the features described and/or depicted, in themselves or in any combination, are generally the subject matter of the invention, irrespective of their combination in the claims or their back-reference. The content of the claims is also made part of the description.

### BRIEF DESCRIPTION OF THE DRAWINGS

The invention is explained in more detail below by means of the drawings and embodiments, wherein:

FIG. 1 shows, by way of example, a schematic diagram of an arrangement of a water treatment unit and a separating device for monitoring the effectiveness of the water treatment unit;

FIG. 2 shows, by way of example, a schematic diagram of a separating device for monitoring the effectiveness of a water treatment process;

FIG. 3 shows, by way of example, a sectional view through the separator according to FIG. 2 along the cutting line A-A;

FIG. 4 shows, by way of example, a sectional view through the separator according to FIG. 2 along the cutting line B-B; and

FIG. 5 shows, by way of example, a schematic diagram of a water-bearing system with a water treatment unit and a separator for monitoring the effectiveness of the water treatment unit.

### DETAILED DESCRIPTION OF THE INVENTION

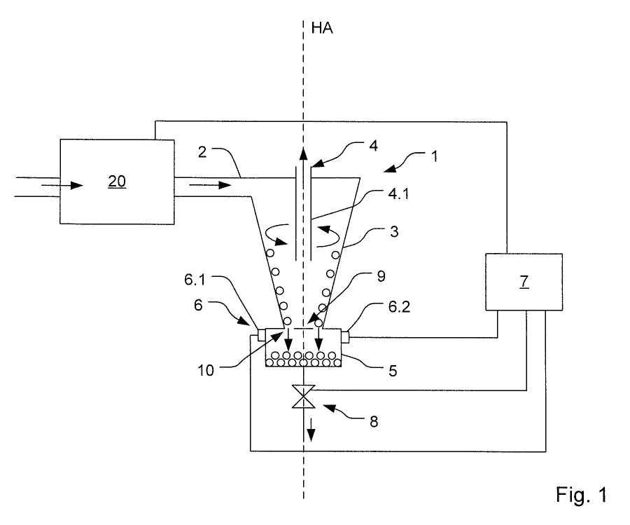

FIG. 1 shows a schematic diagram of an arrangement of a water treatment unit 20 and a separator 1.

Water flows through the water treatment unit 20, as indicated by the arrows as an example. The water treatment unit 20 is designed to cause the precipitation of calcium carbonate microparticles, hereinafter referred to as lime particles, by the effect of a magnetic field on the water or an electrolysis process. European Patent No. EP 0 525 835 A2 teaches, by way of example, such a magnetic field-based water treatment unit.

It is known that such water treatment units 20 can significantly reduce or prevent calcification of the devices integrated in a water circuit, in particular a hot water circuit.

The water escaping from the water treatment unit 20 contains lime particles formed as a result of the precipitation.

In order to be able to check the effectiveness of the water treatment unit 20 during operation, in particular permanently or intermittently at certain intervals, the water containing the lime particles is fed to a separator 1. The separator 1 is designed to separate the lime particles from the water and thus to filter the lime particles out of the water.

The separator 1 substantially consists of a water inlet 2, a separation chamber 3, a collection chamber 5 and a water outlet 4. As shown schematically in FIG. 1, the water that contains lime particles is fed to the separation chamber 3 via the water inlet 2. The water inlet 2 is here preferably arranged relative to the separation chamber 3 in such a way that the water and the lime particles contained therein are set in rotation (see the arrows in FIG. 1 indicating the rotation movement).

The separation chamber 3 is preferably rotationally symmetrical with respect to the vertical normal axis HA, i.e. the inner wall of the separation chamber 3 has a circular or substantially circular cross-section. This promotes the rotational movement of the water in the separation chamber 3.

The lime particles have a higher density than water. Due to the rotational movement of the water, centrifugal forces act on the lime particles so that they are pressed against the inner wall of the separation chamber 3 during the rotational movement of the water due to their higher density.

As shown in FIG. 1, the separation chamber 3 can be designed to taper towards the bottom. In other words, the separation chamber 3 is funnel-shaped or substantially funnel-shaped and tapers downwards. This allows the flow to be accelerated downwards. Alternatively, the separation chamber 3 can have a cylindrical or substantially cylindrical inner wall, i.e. a constant inner diameter towards the bottom.

Due to the flow and gravity, the lime particles settle downwards and are guided into a collection chamber 5 provided below the separation chamber. The filtered water (i.e. the water from which the lime particles were removed), on the other hand, is discharged upwards via the immersion tube 4.1 and the water outlet 4 from the separation chamber 3. The lower free end of the immersion tube 4.1 is preferably below the water inlet 2.

A separating device 9 is provided between the collection chamber 5 and the separation chamber 3 to separate them in sections. The separating device 9 can be saucer- or plate-shaped, for example. The separating device 9 can be selected with regard to its size and arranged in the transition area between the separation chamber 3 and the collection chamber 5 in such a way that a gap 10, in particular an annular gap 10, results between the separating device 9 and an inner wall section of the separator 1 that surrounds this separating device 9. The lime particles moved along the inner wall of the separation chamber 3 can be fed to the collection chamber 5 via this gap 10. The separating device 9 here at least largely prevents a transfer of the rotational movement or flow present in the separation chamber 3 into the collection chamber 5.

As described above, the collection chamber 5 is designed to receive the lime particles separated by centrifugal separation in the separation chamber 3.

A sensor system 6 is provided at the collection chamber 5, on the basis of which the effectiveness of the water treatment can be checked. The sensor system 6, for example, is designed to detect the extent to which lime particles are fed into the collection chamber 5. In particular, the sensor system 6 can determine the concentration of lime particles in the collection chamber 5.

The sensor system 6 here makes use of the fact that lime particles can only be detected in the collection chamber 5 if the water treatment unit 1 precipitates such lime particles. This allows the function of the water treatment unit 20 to be checked via the sensor system 6.

As shown in FIG. 1, the sensor system 6 has a transmitter 6.1 and a receiver 6.2 interacting with this transmitter 6.1. The transmitter 6.1 can, for example, be a light emitting transmitter or a sound signal emitting transmitter. The receiver 6.2 is designed and arranged to receive the signal emitted by the transmitter 6.1. The receiver 6.2 is preferably arranged opposite the transmitter 6.1, so that the receiver 6.2 can detect a signal emitted by the transmitter 6.1, which has at least partially passed through the interior of the collection chamber 5.

Depending on the concentration of the lime particles contained in the collection chamber 5, the signal emitted by the transmitter 6.1 is reflected or attenuated to varying degrees, so that the measuring signal provided by the receiver 6.2 shows a dependence on how many lime particles are separated from the water in the separation chamber 3 and fed to the collection chamber 5. In particular, the measuring signal provided by the receiver 6.2 shows a dependence on how high the concentration (number of lime particles per unit volume of water) of the lime particles is in the water contained in the collection chamber 5.

As shown in FIG. 1, the sensor system 6 is preferably provided in an upper area of the collection chamber 6, preferably directly or substantially directly below the inlet to the collection chamber 5. The sensor system 6 is more preferably provided directly below the separating device 9. As a result, it is possible to measure the concentration of the lime particles in the transition area between the separation chamber 3 and the collection chamber 5, in particular directly after the introduction of the lime particles from the separation chamber 3 into the collection chamber 5.

As shown in FIG. 1, the lime particles are deposited on the bottom side in the collection chamber 5, so that the collection chamber 5 is increasingly filled with lime particles. The sensor system 6 arranged in the upper area of the collection chamber 5 also makes it possible to determine whether a filling level of lime particles has been reached in the collection chamber 5, which makes it necessary to empty the collection chamber 5.

The collection chamber 5 has an outlet at which an outlet valve 8 is provided. In particular, the outlet valve 8 can be an automatically operated outlet valve which is opened automatically if the filling level of lime particles in the collection chamber 5 exceeds a limit value.

The separator 1 or the water treatment unit 20 preferably has an evaluation and control unit 7 which is coupled to the sensor system 6. In particular, the evaluation and control unit 7 causes the transmitter 6.1 to emit a signal. In addition, the evaluation and control unit 7 can be coupled to the receiver 6.2 so that the measuring signal provided by it can be transmitted to the evaluation and control unit 7.

The evaluation and control unit 7 is designed to evaluate the measuring signal and, based on the measuring signal, to determine whether and to what extent the precipitation of lime particles is caused by the water treatment unit 20. In particular, the evaluation and control unit 7 can derive from the measuring signal how high the concentration of the lime particles is in the water contained in the collection chamber 5. In addition, the evaluation and control unit 7 can determine how high the filling level of lime particles within the collection chamber 5 is.

The evaluation and control unit 7 is preferably coupled to the outlet valve 8 via a control line. In the event that the evaluation and control unit 7 determines that the filling level of lime particles in the collection chamber 5 has exceeded a level or threshold value, the evaluation and control unit 7 can cause the outlet valve 8 to open and thus empty the collection chamber 5.

As shown in FIG. 1, the evaluation and control unit 7 can also be coupled to the water treatment unit 20 via a control line. Via this control line, the evaluation and control unit 7 can, for example, control the intensity of the water treatment by the water treatment unit 20. For example, the intensity of the water treatment and/or the operating mode can be changed. This allows the water treatment unit 20 to be controlled via the sensor system 6 and the evaluation and control unit 7 depending on the measuring signal provided by sensor system 6.

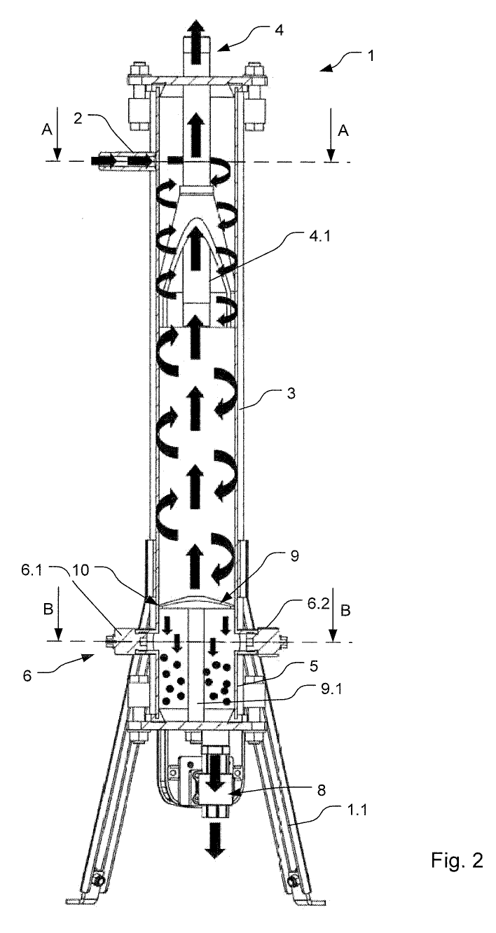

FIGS. 2 to 4 show a further embodiment of a separator 1 for separating lime particles from a water stream. Unless otherwise described below, the above explanations also apply to this embodiment. The separator 1 is substantially tower-shaped with a normal axis HA extending in the vertical direction.

The separator 1 can, for example, have a frame 1.1 so that the separator 1 can be fixed on an installation surface.

In the embodiment shown, the separator 1 comprises a cylindrical or tubular separation chamber 3, the cylindrical axis of which is vertically oriented. The height of the separation chamber 3 is here considerably larger than the diameter thereof.

The collection chamber 5 has the same diameter or substantially the same diameter as the separation chamber 3. The separation between the separation chamber 3 and the collection chamber 5 is again carried out by a separating device 9. This separating device 9, for example, is saucer-shaped and curved in such a way that the central area of the separating device 9 is raised in the direction of the water outlet 4. This allows the transfer of the flow from the separation chamber 3 into the collection chamber 5 to be further reduced.

An immersion pipe 4.1 is preferably provided to discharge the filtered water from the separation chamber. The immersion tube 4.1 is preferably centered in the separation chamber 3 and extends in the vertical direction parallel to the normal axis HA. The free underside end of the immersion tube 4.1 is preferably provided in a plane below the water inlet 2.

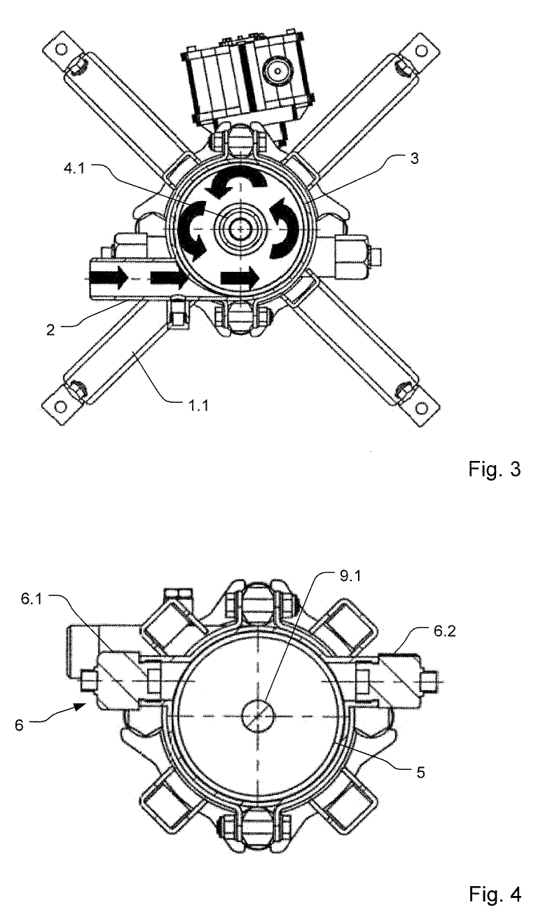

FIG. 3 shows a horizontal section through the separator 1 in the area of the water inlet 2. The water inlet is preferably tangential to the inner wall of the separation chamber 3. As a result, the supplied, lime particle containing water is deflected after entering the separation chamber 3 through the curved inner wall and the water in the separation chamber 3 is set in a rotational movement (as indicated by the arrows in FIGS. 2 and 3).

FIG. 4 shows a further horizontal section through the separator 1 in the area of the sensor system 6. The transmitter 6.1 and the receiver 6.2 are provided opposite each other, namely laterally offset to a line running diametrically through the collection chamber 5. This ensures that a direct signal transmission between transmitter 6.1 and receiver 6.2 through the interior of the collection chamber 5 is possible despite a support section 9.1 of the separating device 9 that is arranged in the cross-section center.

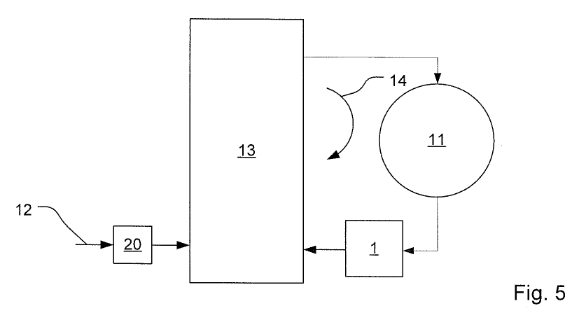

FIG. 5 shows an exemplary integration of the separator 1 into a water circuit, in particular a hot water circuit. Water, in particular cold water, is here fed to a water treatment unit 20 via an inlet 12. After passing through the water treatment unit 20 and the precipitation of calcium carbonate (decarbonization), the water is fed to a water heater 13. The water is heated in this water heater 13. The heated water can then be supplied to a consumer 11 as required. The consumer can, for example, be provided in a hot water circulation 14, i.e. the hot water circulates even if no hot water is consumed by the consumer 11, as indicated by the arrow with the reference sign 14. For example, the separator 1 can be integrated in this hot water circulation 14 in order to filter out lime particles from the water flow and monitor the function of the water treatment unit 20.

It goes without saying that the installation situation shown in FIG. 5 is strictly exemplary and that there are a large number of other installation situations or possible applications for the separator 1. The separator 1 can also be installed in a partial flow of a cooling tower or a circulating spray humidifier, for example.

The invention was described above by means of embodiments. It goes without saying that numerous changes and modifications are possible without abandoning the inventive concept on which the invention is based.

### REFERENCE NO. LIST

1 separator
1.1 frame
2 water inlet
3 separation chamber
4 water outlet
4.1 immersion tube
5 collection chamber
6 sensor system
6.1 transmitter
6.2 receiver
7 evaluation and control unit
8 outlet valve
9 separating device
9.1 support section
10 gap
11 consumers
12 inlet
13 water heater
14 hot water circulation
20 water treatment unit
HA normal axis

What is claimed is:

1. An apparatus for monitoring separation of lime particles from a water stream, comprising:
a water inlet, via which water that contains lime particles is fed,
a separation chamber, within which the lime particles are separated from the water by centrifugal forces,
a water outlet, via which the water from which the lime particles have been separated is discharged,
a collection chamber provided for receiving the lime particles separated from the water, and
a sensor system provided at the collection chamber, by which the sensor system monitors a separation process of the lime particles from the water stream.

2. The apparatus according to claim 1, wherein the sensor system is a sensor system measuring light or sound.

3. The apparatus according to claim 1, wherein the sensor system has an arrangement comprising a transmitter and a receiver, the transmitter supplies a signal emitted by the transmitter through the collection chamber to the receiver.

4. The apparatus according to claim 1, wherein the sensor system is coupled to an evaluation and control unit, by which concentration of lime particles in the collection chamber can be analyzed on a basis of a measuring signal measured at a receiver of the sensor system.

5. The apparatus according to claim 1, wherein the sensor system is coupled to an evaluation and control unit via which a filling level of the lime particles in the collection chamber can be measured.

6. The apparatus according to claim 1, wherein the collection chamber has an outlet valve, which can be moved to an open position on a basis of a measuring signal provided by the sensor system in order to empty the collection chamber.

7. The apparatus according to claim 1, wherein the separation chamber has a round cross-section to create a rotational movement of the water about a vertical normal axis.

8. The apparatus according to claim 1, wherein the water inlet is arranged at the separation chamber in such a way that water is introduced into the separation chamber in a tangential direction.

9. The apparatus according to claim 1, wherein the separation chamber tapers downwards.

10. The apparatus according to claim 1, wherein the collection chamber is arranged below the separation chamber.

11. The apparatus according to claim 1, wherein the collection chamber is separated from the separation chamber by a separating device.

12. The apparatus according to claim 11, wherein by the separating device an edge-side gap is formed between a wall of the separation chamber and the separating device, via which lime particles can be conveyed out of the separation chamber into the collection chamber.

13. The apparatus according to claim 11, wherein the sensor system for monitoring the separation process of the lime particles is provided below the separating device.

14. A method for monitoring function of a water treatment unit, comprising the steps of:
feeding water treated by a water treatment unit into a separation chamber of a separator, in which the water containing lime particles is set into a rotational movement;
separating the lime particles from the water by centrifugal forces acting on the lime particles;
feeding the lime particles into a collection chamber of the separator; and
monitoring separation of the lime particles in the collection chamber by a sensor system.

15. The method according to claim 14, wherein measuring signals provided by the sensor system are fed to an evaluation and control unit and the water treatment unit is controlled based upon evaluation information determined by the evaluation and control unit.
